(19) United States
(12) Patent Application Publication
(10) Pub. No.: US 2007/0280077 A1
(43) Pub. Date: Dec. 6, 2007

(54) Write processing method for optical storage device and optical storage device

(75) Inventor: Shinji Miyamoto, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/890,624

(22) Filed: Aug. 7, 2007

Related U.S. Application Data
(63) Continuation of application No. PCT/JP2005/002268, filed on Feb. 15, 2005.

(51) Int. Cl. G11B 27/36

(52) U.S. Cl. 369/53.35; 369/47.5

(57) ABSTRACT

In order to decrease alternate processing when a verification error is detected for an optical storage medium, a position BS and a length BL of a defect are stored when a verification error is detected, and based on this stored information, rewriting is performed with increasing the write power for the defective section. Thereby even if an LD driver with simple configuration and low price, which is used for APC control for a digital feedback loop by firmware, is used, the emission power can be increased only for the defective section, and the reproducing waveform of the defective section can be increased, and the use of alternate sectors can be decreased when writing is retried.

### CROSS REFERENCE TO RELATED APPLICATIONS

This application is a continuation of International Application No. PCT/JP2005/002268, filed on Feb. 15, 2005, now pending, herein incorporated by reference.

### TECHNICAL FIELD

The present invention relates to a write processing method for an optical storage device and an optical storage device for irradiating light onto an optical storage medium, writing data, then reading the written data and verifying the data, and more particularly to a write processing method for an optical storage device and an optical storage device for rewriting the data if a verify-error is detected when the data is verified.

### BACKGROUND ART

Because of the recent demand to computerize documents and images, demand for higher performance, larger capacity and lower price is increasing for storage devices for storing computerized data. One popular storage device is an optical storage device using an optical storage medium. For example, optical storage devices, using a magneto-optical disk (MO) and optical disk (CD-RW, DVD), are being provided.

In such an optical storage device, data is written by irradiating light onto an optical disk. After writing, this data, written on the optical disk, is read, and it is confirmed whether this data can be read. For example, the data which is read and the written data are compared. This is called “verification”. If a write error is detected in verification (this is called a “verification error”), that is if the collation result is not good, an alternate processing is performed.

As FIG. 9 shows, in an optical disk 70, an area between an inner area 71 and an outer area 72 is used as a user area 73. If a verification error is detected in a sector DS1 during writing tracks in the user area 73, an alternate sector KS1 is set in an alternate area created in an outer area 72, for example, and data to be written to the sector DS1 is written to the alternate sector KS1. This is called “alternate processing”, and alternate processing is performed when an uncorrectable burst error, for example, is detected (e.g. Japanese Patent Application Laid-Open No. H5-347042 (see the Abstract and paragraph [0008])).

One cause of a verification error is the decrease in amplitude of a reproducing signal during reading due to a defect in or dust on the optical storage medium. If the alternate processing is performed, the data in the defective sector DS1 must be read/written using the alternate sector KS1 at a different track position, as shown in FIG. 9, when reading or writing the sectors continuously. Therefore if alternate processing is frequently generated, access time increases, which causes a drop in read/write speed. At the worst, the provided alternate area becomes full, which makes alternate processing impossible, making the medium unusable.

An emission power control (APC) method for an optical disk device is a method of monitoring the reflected light component by an APC (Auto Power Control) detector, and controlling the emission power of the emission unit by constantly operating the APC using hardware.

With this method, the change of the reflected light quantity in a defective section of the medium is detected and the emission power at the defective section is immediately increased. Therefore, because of the increase in write power, the drop in amplitude of the reproducing waveform at the defective section during verification is minor, and verification errors rarely occur.

On the other hand, in the case of performing APC using the firmware of the controller (CPU), the detected light quantity of the APC detector is monitored, light power errors are calculated, and the emission power of the emission section is controlled at every predetermined time, so emission power has a constant light quantity at least within one sector.

In the case of a method for constantly performing APC using conventional hardware, verification errors rarely occur, but the LD (Laser Diode) driver used as this hardware requires an analog feedback loop, so the configuration of the LD driver is complicated, and the LD driver itself is expensive.

In the case of the method for performing APC using firmware, on the other hand, a digital feedback loop is used, so the LD driver of which configuration is simple and price is low can be used. However, as mentioned above, emission power is constant in one sector, so the reproducing waveform becomes small at the defective section, where verification errors are more likely to occur.

### SUMMARY OF THE INVENTION

To achieve the object of solving the above problems, the present invention provides a write processing method for an optical storage device that records data by irradiating light onto an optical storage medium, the method having: a step of writing data onto the optical storage medium by light with a predetermined write power; a step of reading a written area of the optical storage medium and performing verification; a step of storing a position and length from a beginning of data in an area of the optical storage medium in which a verification error is detected in the step of performing verification; and a rewriting step of increasing the write power for an area indicated by the stored position and length from the beginning when the written area of the optical storage medium is rewritten.

The present invention also provides an optical storage device for writing data by irradiating light onto an optical storage medium, having: an optical head for irradiating light onto an optical storage medium; a drive circuit for driving a light emitting element of the optical head; and a control circuit for writing data using light with a predetermined write power by controlling the drive circuit. The control circuit reads the written area of the optical storage medium and performs verification, stores a position and length from a beginning of data in an area of the optical storage medium in which a verification error is detected, and rewrites the data with controlling the drive circuit so as to increase the write power for an area indicated by the stored position and length from the beginning.

In the present invention, it is preferable that the step of performing verification is a step of verifying the write processing on the optical storage medium in sector units, and the step of storing has a step of storing a position and length from a beginning of data of the sector in an area in which the verification error is detected.

It is preferable that the present invention further has a step of reading the rewritten area and performing verification after the rewriting step, and a step of rewriting the data with further increasing the write power when the verification error is detected in the verification.

In the present invention, it is also preferable that the step of writing has a step of sending a voltage instruction value for the write power and a timing signal according to write data from a controller to a drive circuit for driving a light emitting element that irradiates light, and irradiating light with an emission quantity according to the write data to the optical storage medium.

In the present invention, it is also preferable that the rewriting step has a step of sending a voltage instruction value for the increased amount of write power, and a timing signal that increases write power in an area indicated by the stored position and length from the beginning, from the controller to the drive circuit.

It is also preferable that the present invention has a step of performing feedback control for the write power by the controller according to output from a detector for detecting the reflected light of the irradiation light, from the light emitting element, reflected on the optical storage medium.

In the present invention, it is also preferable that the step of storing is executed when detection is made that the verification error is a burst error.

It is also preferable that the present invention further has a step of executing an alternate processing of the sector when the verification error is not cleared even if the rewriting step is repeated for a predetermined number of times.

In the present invention, it is also preferable that the step of writing has a step of writing on an optical disk, using an optical head, by irradiating light onto the optical disk that rotates.

When a verification error is detected, the position and length of a defect are stored, and based on this stored information, the data is rewritten and write power of the defective section is increased. So even if an LD driver with a simple configuration and low price, which is used for APC control for a digital feedback loop by firmware, is used, the emission power can be increased only for the defective section, and the reproducing waveform of the defective section can be increased, and the use of alternate sectors can be decreased when writing is retried.

### BRIEF DESCRIPTION OF THE DRAWINGS

FIG. 1 is a block diagram depicting an optical storage device according to an embodiment of the present invention;

FIG. 2 is a diagram depicting a configuration of an optical system of the optical storage device in FIG. 1;

FIG. 3 is a diagram depicting a write retry operation in write processing according to the present invention;

FIG. 4 is a diagram depicting a reproducing waveform after a write retry according to the present invention;

FIG. 5 is a diagram depicting the signal relationship between the LD driver 31 and the controller 17 in FIG. 1;

FIG. 6 is a flow chart depicting the write processing of the controller 17 in FIG. 1 and FIG. 5;

FIG. 7 is a time chart depicting the rewrite operation when a verification error occurs in FIG. 6;

FIG. 8 is a diagram depicting the write current in FIG. 7; and

FIG. 9 is a diagram depicting a conventional sector alternate processing.

### PREFERRED EMBODIMENTS OF THE INVENTION

Embodiments of the present invention will now be described in the sequence of optical storage device, write processing and other embodiments, but the present invention is not limited to these embodiments but can be modified in various ways.

Optical Storage Device

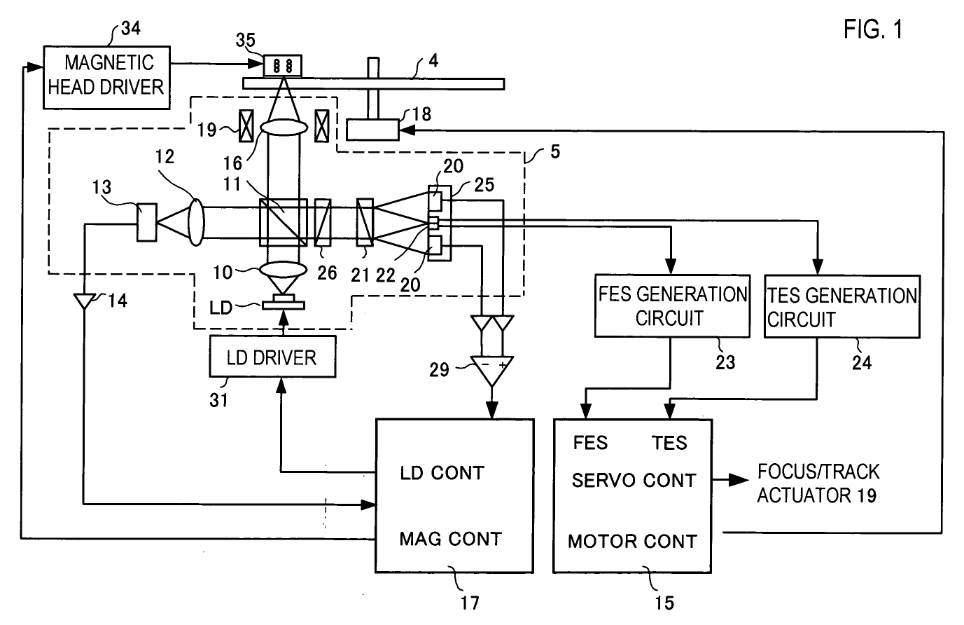

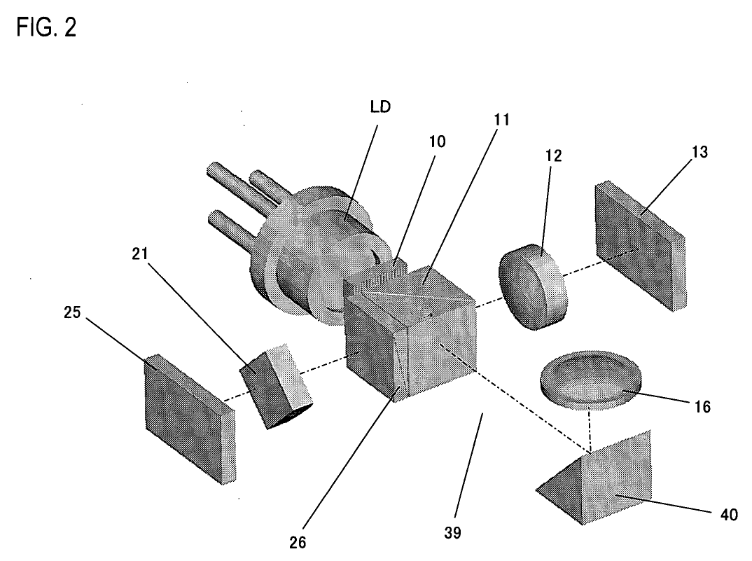

FIG. 1 is a block diagram depicting an optical storage device according to an embodiment of the present invention, and FIG. 2 is a diagram depicting a configuration of an optical system of the optical storage device in FIG. 1. In FIG. 1, a magneto-optical disk device is shown as an example of the optical storage device.

As FIG. 1 shows, the magneto-optical disk device, as an optical storage device, rotates a magneto-optical recording medium, which is an optical storage medium, and writes data by light and magnetism and reads data by light. A motor 18 rotates a magneto-optical recording medium (MO disk) 4. Normally the MO disk 4 is a removable medium, and is inserted through an insertion slot of a drive, which is not illustrated.

An optical pickup 5 is disposed so as to sandwich the MO disk 4 with a magnetic generation unit (called “magnetic head” here) 35. The optical pickup 5 is moved by an actuator (not illustrated), such as a ball screw feed mechanism, and can access any position on the MO disk 4 in the radius direction. Also an LD driver 31 for driving a laser diode LD of the optical pickup 5 and a magnetic head driver 34 for driving the magnetic head 35 are installed.

A servo controller for accessing 15 servo-controls an actuator (not illustrated), the motor 18 and a focus/track actuator 19 of the optical pickup 5 using output from the optical pickup 5.

A main controller 17 operates the LD driver 31, the magnetic head driver 34 and servo-controller for accessing 15 to record/reproduce information.

The optical pickup 5 will be described in detail with reference to FIG. 1 and FIG. 2. Diffused lights from a laser diode LD become parallel lights by a collimator lens 10 and condensed on the MO disk 4, almost to the diffraction limit, by an objective lens 16 after being reflected by a mirror 40 via a beam splitter 11.

A part of the lights which enter the beam splitter 11 are reflected by the beam splitter 11, and are condensed on an APC (Auto Power Control) detector 13 via a condenser lens 12.

Lights reflected by the MO disk 4 are reflected by the mirror 40 via the objective lens 16 again, and enter the beam splitter 11 again. A part of the lights which entered the beam splitter 11 return to the laser diode LD side, and the rest of the lights are reflected by the beam splitter 11, and are condensed on a reflected light detector 25 via a three-beam Wollaston prism 26 and a prism 21 for Foucault method detection.

The reflected light detector 25 is comprised of a four-division detector 22 for servo-detection and MO signal detector 20 disposed at the top and bottom thereof as shown in FIG. 1.

As FIG. 1 shows, an FES (Focus Error Signal) reproducing circuit 23 performs focus error detection (FES) based on an astigmatism method, using outputs A, B, C and D of a photoelectric-converted four division photo-detector 22 as follows: FES=(A+B)−(C+D)/(A+B+C+D). At the same time, a TES generation circuit 24 detects a tracking error (TES) from the output of the photo-detector 22 as follows based on a push-pull method:
TES=(A+C)−(B+D)/(A+B+C+D).

The focusing error signal (FES) and the tracking error signal (TES) determined by the above calculations are input to the servo controller for accessing 15 as position error signals in the focusing direction and tracking direction.

On the other hand, the polarization characteristic of the reflected laser light changes depending on the magnetization direction of the magneto-optical recording on the MO disk 4, and is converted into light intensity when reproducing is performed. In other words, in the three-beam Wollaston prism 26, the lights are separated into two beams, of which polarization directions are perpendicular to each other, by polarization detection, and the beams enter the two-division photo-detector 20 through the cylindrical surface lens 21, and are photoelectric-converted respectively.

Two electric signals, G and H, photoelectric-converted in the two-division photo-detector 20, are subtracted by a subtraction amplifier (read circuit) 29 to generate a read (MO) signal (RAM=G−H), which is input to the main controller 17.

Monitor output, which is the result after the reflected light of the semiconductor laser diode LD entered a photo-detector for APC 13 is photoelectric-converted, is also input to the main controller 17 via an amplifier 14.

The main controller 17 also generates a command signal for the LD driver 31 according to the recording/reproducing mode. In other words, the main controller 17 sends the data power error corresponding to this monitor output to the LD driver 31, and performs negative feedback control for the emission power of the semiconductor laser diode LD.

When magneto-optical recording is performed using a light modulation recording system, the write data is sent to the LD driver 31, and the laser diode LD is driven for light modulation. In this case, the main controller 17 sends the signal to instruct recording to the LD driver 31, and the LD driver 31 performs negative feedback control for the emission of the semiconductor laser diode LD so as to be an optimum laser power for recording.

In the above description, the focusing error signal is detected by an astigmatism method, the tracking error signal is detected by a push-pull method, and the MO signal is detected by the difference detection signal of the polarization components as an example, but the above mentioned optical system is one used for the present embodiment, and a knife edge method or a spot size position detection method, for example, can be used for the focusing error detection method without problems. Also for the tracking error detection method, the three-beam method or the phase difference method, for example, can be used without problems.

The servo controller 15 also drives a focus coil of a focus/track actuator 19 according to the detected focusing error signal FES, and controls the optical beam to the focal point. The servo controller 15 also drives the track coil of the focus/track actuator 19 according to the detected tracking error signal TES, and controls the optical beam to follow up the track.

Write Processing

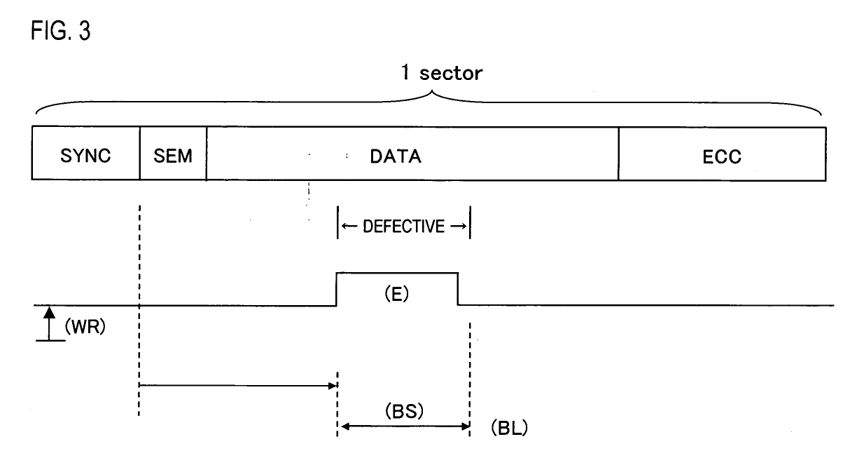

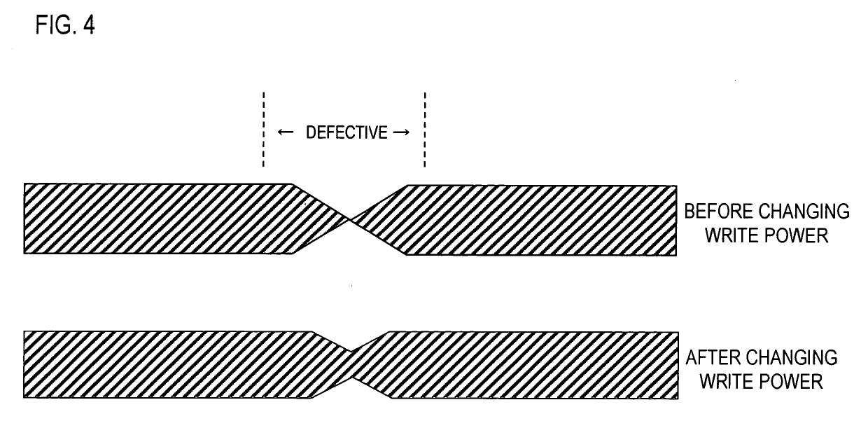

FIG. 3 is a diagram depicting a write retry operation in the write processing of the present invention, and FIG. 4 is a diagram depicting a reproducing waveform after write retry according to the present invention.

FIG. 3 shows a format of one sector of the MO disk 4. One sector is comprised of frequency synchronous section SYNC, sector beginning mark SEM, data area DATA and ECC (error correction code) section.

When this sector is written, this sector is read and verified. During this verification, if a defective section, where the written data and read data for verification are different, is detected, the controller 17 stores the beginning position BS of the defective section and the length BL of the defective section from the beginning of the sector beginning mark.

In the case of a verification error, when the same sector is rewritten, the write power is intentionally set higher only for the time B (BS, BL), that is the section from the position BS to BL from the sector beginning mark. In other words, a write bias power E is added to the average power WR of writing only for the defective section.

Normally the amplitude of the read waveform increases in proportion to the write power, so the amplitude of the reproducing waveform of the defective section becomes larger if the present invention is applied, and it is less likely for a verification error to occur compared with the case of not applying the present invention, as shown in FIG. 4.

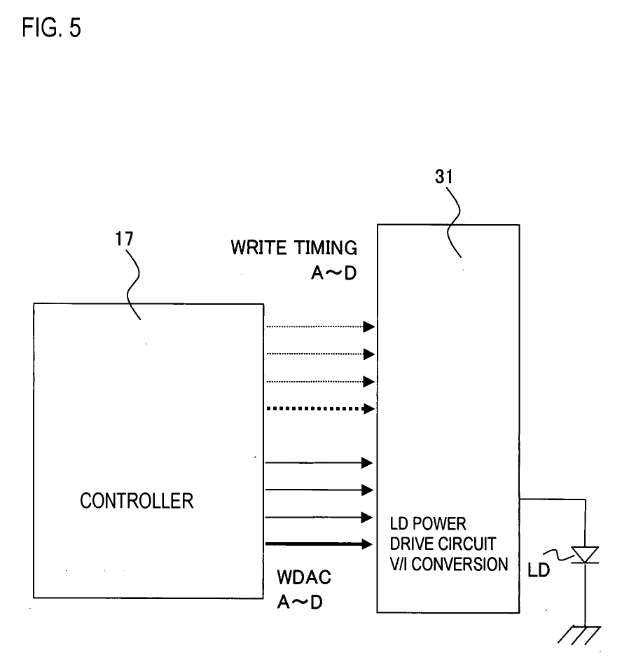

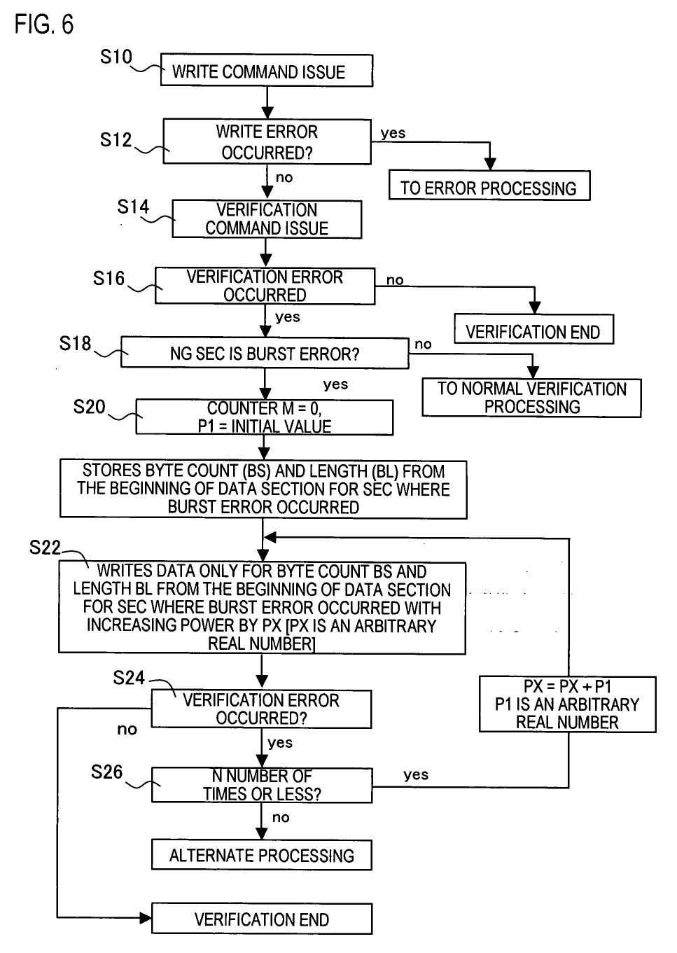

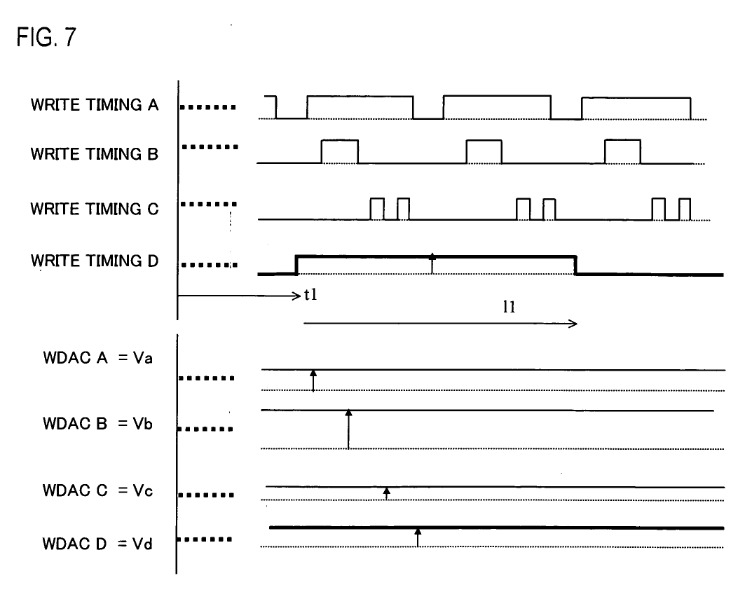

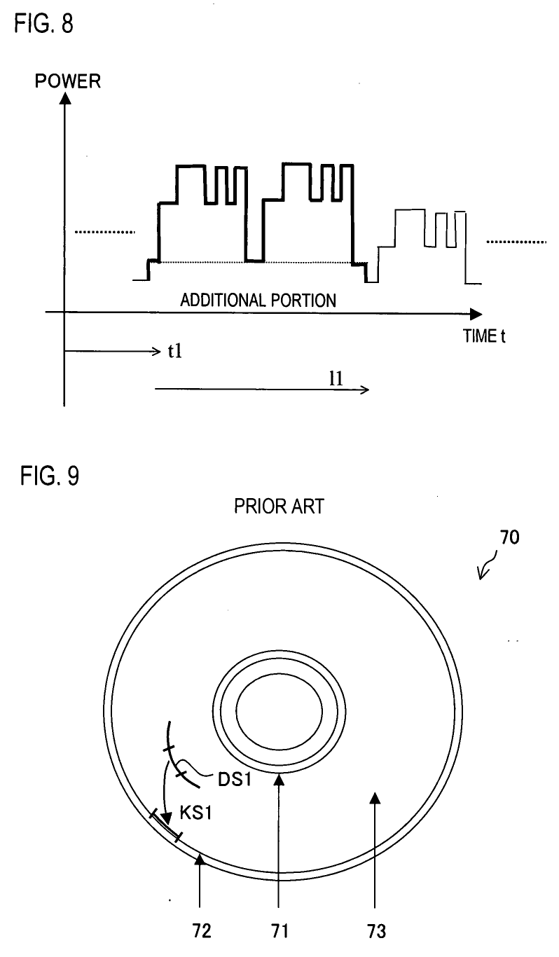

FIG. 5 is a diagram depicting the signal relationship between the LD driver 31 and the controller 17 in FIG. 1, FIG. 6 is a flow chart depicting the write processing of the controller 17, FIG. 7 is a time chart depicting the rewrite operation when a verification error occurs, and FIG. 8 is a diagram depicting the write current thereby.

As FIG. 5 shows, the LD driver 31 is comprised of a power addition (and subtraction) circuit and a voltage/current conversion circuit. Here FIG. 5 shows the power control of the controller 17 when write processing is performed. Normally when the medium 4 is written, the controller 17 sets the voltage value (power) by the three write digital values WDACA to WDACC, as described in FIG. 7, as the power control, then turns the write timing circuit of the LD driver circuit 31 ON at a set write timing A to C when this power is set.

Only at the timing which is set, the LD driver 31 converts the voltages instructed by WDAA to WDAC into currents (VI conversion), adds these currents, and supplies it to the laser diode LD.

Here for the handling of the defective section, the digital value WDACD and the write timing D are set separately for the voltage value from the controller 17 to the LD driver 31.

Now the write processing by the controller 17 in FIG. 6 will be described with reference to FIG. 7 and FIG. 8.

(S10) The controller 17 issues the write command and executes the write operation. For the write operation, the controller 17 sets the voltage value (power) with the three write digital values WDACA to WDACC, as shown in FIG. 7, and turns the write timing circuit of the LD driver 31 ON at a write timing A to C when this power is set. The write digital value WDACA is a write bias voltage Va for a reference voltage (e.g. read voltage), and the write digital values WDACB and WDCAC are voltages Vb and Vc of the write data (“1”).

(S12) The controller 17 judges whether the data is written normally in the sector of the desired track (whether a write error exists) by the shift or fluctuation of the position error from the track during the write operation. If a write error is detected, processing advances to error processing.

(S14) Then the controller 17 issues the verification command and performs verification. In other words, the data in this written sector is read and compared with the write data.

(S16) By this comparison, the controller 17 judges whether a verification error exists. If it is judged that no verification error exists, verification ends normally.

(S18) If it is judged that a verification error occurred, the controller 17 judges whether the verification error which occurred in a sector is a burst error. If it is not a burst error, in other words, if it is not a verification error which occurred in a plurality of continuous bytes, then this could be a simple read error, so processing advances to normal verification processing. For example, the verification operation is retried.

(S20) If it is judged that the verification error exists and the verification error which occurred in a sector is a burst error, then the controller 17 sets the retry counter M of the verification error to “0”, and sets the power addition value P1 to the initial value. And for the sector judged as where a burst error occurred, the controller 17 stores the beginning position BS of the defect and the length BL of the defective section indicated by the byte count from the data beginning section, as described in FIG. 3.

(S22) Then the controller 17 performs a write retry. At this time, the voltage and timing are specified in the same way as step S10, and power is increased by the amount of PX only for the portion with the beginning position BS of the defect and length BL of the defective section indicated by the byte count from the data beginning section. In FIG. 7, in the write retry of the burst error, the voltage Vd corresponding to PX is instructed for WDACD, and the timing signal D is set to “1” at time t1 corresponding to BS, and the period “1” is continued for time 11 corresponding to the length BS, then the timing signal D is returned to “0”. By this, as shown in FIG. 8, the amount for voltage Vd is added to the write power (write current) during time 11 after time t1.

(S24) Just like steps S14 and S16, the controller 17 issues the verification command and performs verification. In other words, the written data in this sector is read and compared with the write data. By this comparison, the controller 17 judges whether a verification error exists. If it is judged that no verification error exists, verification ends normally.

(S26) Then the controller 17 increments the counter M by “1”, and judges whether the counter M is the retry limit count value N (e.g. 3) or less. If the counter M is the retry limit count value N (e.g. 3) or less, processing returns to step S22, and write retry is performed. In this case, the above mentioned additional power PX is increased to PX+P1, the addition voltage Vd is updated to Vd+ΔV, and then write retry is performed. If the counter M is not the retry limit count value N (e.g. 3) or less, this means that retry is over, alternate processing is performed.

In this way, when it is judged that a verification error occurred, write retry is performed, and a predetermined arbitrary voltage is set in this write retry, and write timing is turned ON only for the position and length B (BS, BL) from the beginning of the data section of the sector where the verification error occurred. Since the write power increases in the defective section when the write retry is performed, the reproducing waveform in the defective section is increased, and alternate sectors can be decreased.

For the calculation of the position of the defective section, the controller 17 can know the location of the data error which occurred to the write data when verification is performed after writing, so the position and the length from the beginning of the error section can be easily known by byte count.

Also retry is performed even in write retry, and write power is sequentially increased according to the retry count, so even if the defective content of the defective section is minor, a minimum addition of write power is sufficient, but if serious, a maximum addition of write power is used, which minimizes damage to the medium.

Therefore even if an LD driver with simple configuration and low price, which is used for APC control for a digital feedback loop by firmware, is used, the emission power can be increased only for the defective section, and the reproducing waveform of the defective section can be increased. Therefore, the count of the alternate processing and the use of alternate sectors that must be secured on the medium, can be decreased.

Also the write power for the defective section of the sector is increased, instead of increasing the write power for an entire defective sector, so the influence of residual heat on adjacent tracks can be minimized, and data on the adjacent sectors can be effectively protected from damage.

### OTHER EMBODIMENTS

In the above embodiment, the control signal line of the controller and the LD driver was described using the configuration in FIG. 5, but other modes can also be used, and the example of adding the control signal line was described, but the present invention can also be applied to a mode where the control signal line is not added.

In the above description, a disk is used for the optical storage device, but the shape is not limited to a disk, but a card shape, for example, may be used. The optical storage device was described using the magneto-optical disk device as an example, but the present invention can also be applied to other optical disk drives.

Also when a sector in a track of the disk is written, if the above mentioned defect is detected in a sector at a same position of one or a plurality of adjacent tracks, then it is likely that a defect exists in this sector to be written, so processing to increase the write power in the area with the position and length of this sector may be executed in the write process before detecting the verification error.

The present invention was described using embodiments, but the present invention can be modified in various ways within the scope of the essential character of the present invention, and these variant forms shall not be excluded from the scope of the present invention.

### INDUSTRIAL APPLICABILITY

Even if an LD driver with simple configuration and low price, used for APC control for a digital feedback loop by firmware, is used, the emission power can be increased only for the defective section when write retry is performed, the reproducing waveform of the defective section can be increased. Therefore the count of alternate processing and the number of alternate sectors to be secured for the medium can be decreased.

Accordingly even if a device with low price is used, the alternate processing can be decreased, a shift of the head to an alternate area can be minimized, a drop in access performance of the device can be prevented, and long term use can be implemented.

1. A write processing method for an optical storage device that writes data by irradiating light onto an optical storage medium, comprising:
a step of writing data onto said optical storage medium by light with a predetermined write power;
a step of reading a written area of said optical storage medium and performing verification;
a step of storing a position and length from a beginning of data in an area of said optical storage medium in which a verification error is detected in said step of performing verification; and
a rewriting step of increasing the write power for an area indicated by said stored position and length from said beginning and rewriting said written area of said optical storage medium.

2. The write processing method for an optical storage device according to claim 1, wherein
said step of performing verification comprises a step of verifying said write processing on said optical storage medium in sector units, and
said step of storing comprises a step of storing a position and length from the beginning of data of said sector in an area in which said verification error is detected.

3. The write processing method for an optical storage device according to claim 1, further comprising:
a step of reading said rewritten area and performing verification after said rewriting step; and
a step of rewriting the data with further increasing said write power when said verification error is detected in said verification.

4. The write processing method for an optical storage device according to claim 1, wherein
said step of writing comprises a step of sending a voltage instruction value for said write power and a timing signal according to write data from a controller to a drive circuit for driving a light emitting element that irradiates said light, and irradiating light with emission quantity according to the write data to said optical storage medium.

5. The write processing method for an optical storage device according to claim 4, wherein
said rewriting step comprises a step of sending a voltage instruction value for said increased amount of write power, and a timing signal that increases write power in an area indicated by said stored position and length from said beginning, from said controller to said drive circuit.

6. The write processing method for an optical storage device according to claim 4, further comprising
a step of performing feedback control for said write power by said controller according to output from a detector for detecting reflected light of said irradiation light, from said light-emitting element, reflected on said optical storage medium.

7. The write processing method for an optical storage device according to claim 1, wherein said step of storing is executed when detection is made that said verification error is a burst error.

8. The write processing method for an optical storage device according to claim 3, further comprising:
a step of executing an alternate processing of said sector when said verification error is not cleared even if said rewriting step is repeated for a predetermined number of times.

9. The write processing method for an optical storage device according to claim 1, wherein said step of writing comprises a step of writing data on an optical disk by irradiating light onto said optical disk that rotates using an optical head.

10. An optical storage device for writing data by irradiating light onto an optical storage medium, comprising:
an optical head for irradiating light onto said optical storage medium;
a drive circuit for driving a light emitting element of said optical head; and
a control circuit for writing data using light with a predetermined write power by controlling said drive circuit, wherein
said control circuit reads a written area of said optical storage medium and performs verification, stores a position and length from a beginning of data in an area of said optical storage medium in which a verification error is detected, and rewrites said data by controlling said drive circuit so as to increase write power for an area indicated by said stored position and length from said beginning.

11. The optical storage device according to claim 10, wherein said control circuit verifies said write processing on said optical storage medium in sector units, and stores a position and length from the beginning of data of said sector in an area in which said verification error is detected.

12. The optical storage device according to claim 10, wherein said control circuit reads said rewritten area and performs verification after said rewriting, and rewrites the data with further increasing said write power when said verification error is detected in said verification.

13. The optical storage device according to claim 10, wherein
said control circuit sends a voltage instruction value for said write power and a timing signal according to write data to said drive circuit,
and said drive circuit drives a light emitting element according to said voltage instruction value and said timing signal and irradiates light with emission quantity according to the write data onto said optical storage medium.

14. The optical storage device according to claim 13, wherein
said control circuit sends a voltage instruction value for said increased amount of write power, and a timing signal for increasing the write power in an area indicated by said stored position and length from said beginning to said drive circuit and performs rewrite again.

15. The optical storage device according to claim 13, wherein
said optical head comprises a detector for detecting reflected light of said irradiation light, from said light emitting element, reflected on said optical storage medium, and
said control circuit performs feedback control for said write power according to output from said detector.

16. The optical storage device according to claim 10, wherein said control circuit stores said position and length when detection is made that said verification error is a burst error.

17. The optical storage device according to claim 14, wherein said control circuit executes an alternate processing of said sector when said verification error is not cleared even if said rewriting is repeated for a predetermined number of times.

18. The optical storage device according to claim 10, wherein said optical storage medium comprises an optical disk that rotates.
